(19) United States
(12) Patent Application Publication
(10) Pub. No.: US 2003/0094551 A1
(43) Pub. Date: May 22, 2003

(54) Universal post base

(76) Inventor: Daniel S. Corrales, Torrance, CA (US)

Correspondence Address: Bruce B. Brunda, Suite 250, 75 Enterprise, Aliso Viejo, CA, 92656, US

(21) Appl. No.: 09/990,602

(22) Filed: Nov. 21, 2001

(51) Int. Cl. F16M 11/00

(52) U.S. Cl. 248/163.1

(57) ABSTRACT

The present invention relates to a universal post base for supporting a chair having an elongated and generally tubular body. The body includes upper and lower surfaces and a plurality of outer channels disposed longitudinally along the body. The post base may further include a plurality of post support members, at least a portion of each post support member defining a cross-section substantially corresponding to the outer channels such that the post support members are retractably engageable with the outer channels. Moreover, the post support members define a support area extending radially from the tubular body for supporting the chair.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates to the field of universal post bases for supporting a chair. Specifically, the base has an elongated and generally tubular body and includes upper and lower surfaces. The body further includes a plurality of outer channels disposed longitudinally along the body. The base further includes a plurality of post support members, at least a portion of each member defining a cross-section substantially corresponding to the channels such that the members are retractably engageable to the outer channels, the post support members defining a support area extending radially from the tubular body for supporting the chair.

It is well known that chairs are constructed having a structure which is capable of supporting an individual's weight. Some common chairs provide four or more legs extending vertically downward relative the chair's seat as a means of supporting weight placed on the chair. Other chairs are constructed using a chair post having a plurality of legs extending horizontally outward from the chair post to create a support base. Each of these legs typically has a wheel attached thereto for allowing the chair to be easily moved around by the user. Such a design is generally well suited to continually support great amounts of weight because the base may evenly distribute the weight to the legs. While such even weight distribution properties are advantageous, there are several deficiencies in conventional chair post bases which may be improved upon.

Some of the prior art chair post bases are designed as one-piece. In this respect, the base is typically manufactured by spot-welding the legs to the post. Such spot-welding creates a permanent connection between the legs and the post to ultimately create a one-piece base. When the chair manufacturer ships a completed chair to the retailer, the one-piece design presents a problem due to its substantially large size and shape. Generally, larger chair bases provide greater support so many chair manufacturers must ship chairs having preconstructed one-piece bases in substantially large boxes. One problem with such a design is that the size of the box becomes too large, which is more expensive to ship than a smaller box. In this respect, it is generally more expensive to larger parcels through many of the known shipping providers. Moreover, larger boxes being shipped through cargo trucks and planes occupy greater space than smaller boxes, allowing fewer of the same boxes to be shipped in a single shipment. Thus, larger shipping boxes present a disadvantage by being more bulky and more expensive than smaller boxes.

Additionally, such increased shipping costs are disadvantageous for both manufacturers and retailers. As for manufacturers, each piece of a chair may be produced in several locations rather than one and manufacturers may incur higher production costs as a result of larger chair bases. For example, a chair seat may be constructed using leather and other fabrics in one facility while the chair post and legs may be constructed at another facility or by third party contractors. In this respect, the independently manufactured chair post and legs may need to be shipped to a different facility for final assembly or for packing into a larger box. A chair base constructed as one piece would then present the problem of requiring greater shipping space and cost than if the chair base could be broken down into component parts.

While it may be advantageous to provide for a chair post and corresponding legs which are shipped as component pieces, such a design must also be well-suited to be understood and assembled by the layman consumer. Some products require the use of tools and extensive directions which the consumer must read and fully understand before assembling the product. Most consumers find such a process very tedious and undesirable. Some of the prior art conventional post bases require the use of allen wrenches and other tools in assembling the chair. While component piece designs may be shipped in smaller boxes, a user-friendly design should also be considered. Therefore, consumers may benefit from a user-friendly universal post base which does not require the use of tools for assembly.

It is also well known that consumers greatly benefit from products which may be easily disassembled, transported, and reassembled with little difficulty. Fold-up chairs are an example of such products due to their ability to be assembled and disassembled in a relatively short period of time. Such products are versatile in their ability to be readily transported and reassembled in little time. Therefore, products which are portable, collapsible, or those which may be quickly disassembled and then later reassembled, are highly desirable to consumers.

Accordingly, there exists a need for a universal post base which may be shipped with the legs as components, rather than as one-piece, to reduce the overall size of the shipping containers, thereby reducing the costs associated with such shipping. There is also a need for such a universal post base allowing for quick assembly and disassembly without the use of tools.

### BRIEF SUMMARY OF THE INVENTION

The present invention specifically addresses and alleviates the above-identified deficiencies in the art. Specifically, the present invention provides for a chair post base which may be assembled and disassembled into its component parts (e.g. post-support members and body) without the use of tools. Eliminating such a necessity for tools, the present invention provides a user-friendly design which may be readily transported by a consumer by quickly disassembling the base. Furthermore, when disassembled, the base may be shipped in relatively small containers for less costly shipping.

Specifically, the post support members may be attached to the body of the universal post support via frictional engagement of the members within the body's outer channels. Alternatively, the members may be retained within the channels via the use of a retainer plug and a retainer disc frictionally insertable into the body and having a size and configuration complimentary to the members. Further, a fastener may be provided to threadably engage the body and act in conjunction with the disc to retain the members within the channels. Even further, the body may be formed having snap-tabs which engage the member when inserted into the channels.

Importantly, the universal post base formed according to the present invention provides for a versatile chair post base which may be formed to fit a variety of chair applications and may provide support for any type of chair. While the present invention may be used to support a chair, it is also contemplated that the universal post base may provide support for any objects which require a support base that may be quickly assembled and disassembled without tools (i.e. tables, hat racks, stools, etc).

In accordance with the present invention, there is provided a universal post base for supporting a chair. The universal post base comprises an elongated and generally tubular body having upper and lower surfaces. Further, there are a plurality of outer channels that are disposed longitudinally along the body.

The universal post base also includes a plurality of post support members. At least a portion of each member defines a cross-section which substantially corresponds to the channels such that the members are retractably engageable with the tubular body channels. The post support members define a support area which extends radially from the tubular body for supporting the chair.

In accordance with a preferred embodiment of the present invention, each post support member has a substantially straight portion for engaging the outer channel a substantially curved portion for defining a support base. Moreover, the substantially straight portion may be frictionally insertable within the outer channels and retainable therein.

In the preferred embodiment, the body and the post support members are each formed from an aluminum material. The universal post base may further comprise a retainer disc defining a plurality of recesses formed thereon for receiving the post support members. Moreover, the universal post base may further comprise a tubular retainer plug having a plurality of radially extending protrusions for frictionally securing the plug into the body. The retainer disc has a central aperture for receiving the plug therethrough. Further, the central aperture is sized and configured to correspond to the protrusions of the plug so as to mitigate rotational movement of the disc when the plug is axially inserted through the central aperture.

The plug may be axially insertable through the central aperture of the disc. The plug may further be frictionally insertable into body through the lower surface. The retainer disc and the plug may collectively urge the members into the channels via the recesses and to retain the members within the channels. Alternatively, the plug may be insertable into the body through the upper surface thereof and frictionally retainable therein via the protrusions. The plug may further have a first end forming a circular-shaped rim. The first end and the rim may be disposed in coaxial relationship with each other. Preferably, the circular-shaped rim has a larger diameter than the plug for mitigating longitudinal movement of the retainer disc when the pug is axially inserted through the central aperture.

In accordance with a preferred embodiment of the present invention, the plug may define a chair-receivable opening sized and configured for receiving a chair seat. The universal post base may further comprise a member-securing plate formed within the body adjacent the lower surface thereof, wherein the plate has a centrally disposed threadably engageable portion formed therein. In addition, the universal post base may further comprise a fastener axially insertable through the central aperture of the retainer disc. This fastener may further be matable with the threadably engageable portion. The disc and the fastener may collectively urge the members into the outer channels via the recesses and to retain the members within the outer channels.

The threadably engageable portion may be a threaded nut integrally formed within the member-securing plate. The fastener may be a threaded hand-screw. The body may further comprise a plurality of snap-tabs disposed about the outer periphery. The snap-tabs may be embedded within the channels and outwardly protrude therefrom. The first end of each post support member may define a snap-tab recess formed for matably receiving the snap-tabs.

The universal post base may further comprise a spring mechanism that is in mechanical communication with each of the snap-tabs. The spring mechanism may be operative to provide compressive force to the snap-tabs and matably engage the snap-tab recess so as to retain the members within the channels. Each of the snap tabs and spring mechanisms may be embedded within a snap-tab plate formed within the lower surface of the hollow passageway. The universal post base may further comprise a cylindrical retainer ring which is sized and configured to slide over the first ends of the members secured within the channels.

### BRIEF DESCRIPTION OF THE DRAWINGS

These as well as other features of the present invention will become more apparent upon reference to the drawings wherein:

FIG. 1 is a perspective view showing a first embodiment of the present invention.

FIG. 2 is an exploded perspective view of a first embodiment of the present invention.

FIG. 3 is a cross-sectional cut-away view of a first embodiment of the present invention showing the body in a vertical position.

FIG. 4 is cross-sectional view of a second embodiment of the present invention showing the body in a horizontal position.

FIG. 4A is a cross-sectional view of a second embodiment of the present invention.

FIG. 5 is a cross-sectional view of a first embodiment of the present invention.

FIG. 6 is an exploded perspective view of a third embodiment of the present invention.

FIG. 7 is a cross-sectional view of a third embodiment of the present invention.

FIG. 8 is an exploded view of a second embodiment of the present invention.

FIG. 9 is a cross-sectional view of a second embodiment of the present invention showing the body in a vertical position.

### DETAILED DESCRIPTION OF THE INVENTION

The detailed description, as set forth below in connection with the appended drawings, is intended as a description of the presently preferred embodiments of the invention, and is not intended to represent the only form in which the present invention may be constructed or utilized.

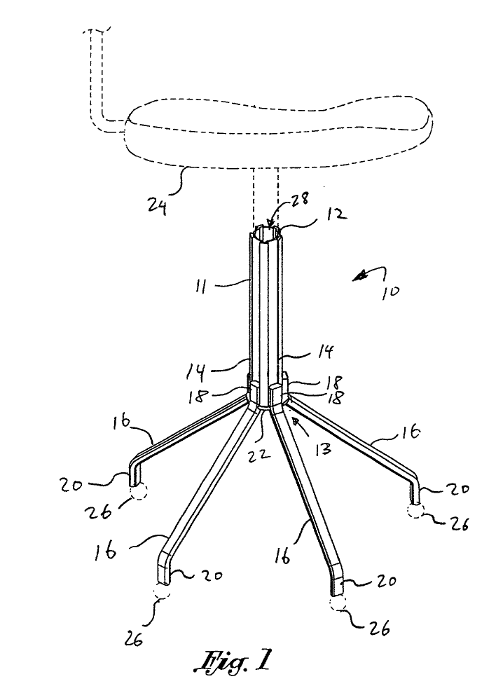

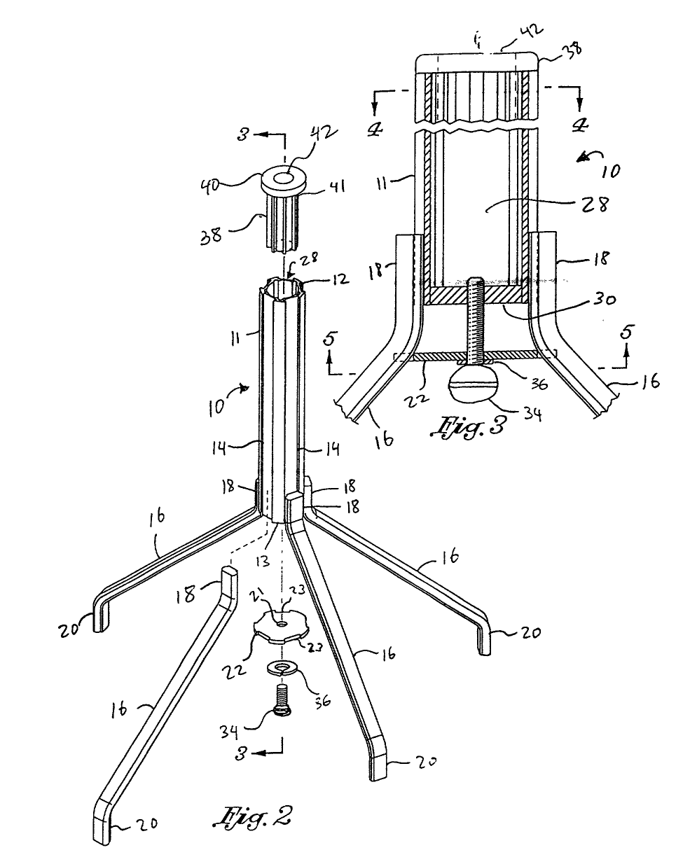

Referring now to the drawings wherein the showings are for the purposes of illustrating preferred embodiments of the present invention only, and not for the purposes of limiting the same, FIG. 1 shows a perspective view of the first embodiment of universal post base 10 made according to the present invention, FIG. 2 shows an exploded perspective view of the first embodiment of universal post base 10 made according to the present invention, FIG. 3 shows a cross-sectional cut-away view of the first embodiment showing the body 11 in an vertical position, and FIG. 5 shows a cross-sectional view of the first embodiment showing the body 11 in a horizontal position.

An elongated and generally tubular body 11 may be formed having upper and lower surfaces 12 and 13 which define a hollow passageway 28 extending therebetween. The upper surface 12 may be sized and configured to receive a chair 24 such that the chair 24 may be insertable into the body 11 through the upper surface 12. The body 11 may be formed having a plurality of outer channels 14 disposed longitudinally along an outer periphery of the body 11. Such channels 14 may be formed as sunken in recesses which extend the entire length of the body 11. Furthermore, a lower surface 13 may be formed on the bottom portion of the body 11. A plurality of post support members 16 may be engaged to the body 11 via the outer channels 14. Each of the post support members 16 defining a cross-section substantially corresponding to the outer channels 14. The members 16 define a support area extending radially from the body 11 for supporting the chair 24 among the members 16. The support area should uniformly distribute weight placed upon the chair 24 among the members 16.

Preferably, each member 16 is constructed having a substantially straight portion 18 for engaging the outer channels 14 and a substantially curved portion 20. The substantially straight portion 18 and the curved portion 20 may be formed as bent in opposite directions from the intermediate portion of the post support members 16. The angle at which the substantially straight portion 18 and the substantially curved portion 20 may be bent is not crucial. However, it is preferable that the straight portion 18 and the substantially curved portion 20 should be bent at approximately 45 degrees relative the intermediate portion of the member 16. Preferably, the straight portion 18 is not angled relative the intermediate portion and is substantially flush with the body 11 when engaged within the outer channels 14. Advantageously however, such a design providing the straight portion 18 and the curved portion 20 bent in opposite directions allows for simple assembly of the member 16. Specifically, the member 16 may be formed such that it is unmistakably clear that the substantially straight portion 18 is the only end which may engage the channel 14. While at least a portion of the members 16 should be formed defining a cross-section substantially corresponding to the channels 14, it is preferable that such portion be formed as a ridge. A ridge is preferably cut into each side of the member 16 and continuous throughout. In this respect, the member 16 may be formed from extruded aluminum and then later bent at desirable angles to form the straight portion 18 and the curved portions 20. Each of the support members 16 may further be formed having a wheel 26 attached to each member 16. Such wheels 26 allow for the base 10 to be movable by a user sitting on the chair 24.

In the lower surface 13 of the body 11, a retainer disc 22 may be attached thereto. The disc 22 may be formed defining a plurality of recesses 23 formed thereon for receiving the post support members 16. The recesses 23 formed on the disc 22 are formed having a size and shape complimentary to the size and shape of the substantially straight portion 18 of the members 16. Alternatively, the substantially straight portion 18 of each member 16 may be slidably and frictionally inserted within the channel 14 and retained therein via a frictional fit. Advantageously, in such a configuration, the members 16 may be secured to the body 11 without the use of any additional components and removable therefrom in the same respect.

The body 11 may further be formed having a member-securing plate 30 formed in the body 11 through the lower surface 13, the plate 30 having a centrally disposed threadably engageable portion 32 formed therein. The plate 30 may be formed as a circular disc which may be welded or crimped to the body 11 in the lower surface 13. Or alternatively, the plate 30 may be frictionally retained within the body and/or be retained within via the use of springs. The threadably engageable portion 32 is preferably formed as a threaded nut. Furthermore, a member-securing fastener 34 axially insertable through the central aperture 21 of the disc 22 may be used in conjunction with the disc 22 to collectively urge the members 16 into the channels 14. In this respect, the disc 22 provides support by retaining the members 16 in place and the fastener 34 is operative to fix the members 16 in such a position within the outer channels 14. The fastener 34 is preferably a threaded hand-screw which may be torqued by hand without the use of any tools and may further be matable with the threadably engageable portion 32. In this respect, the fastener 34 acts in conjunction with the disc 22 to urge the members 16 into the channels 14 via the recesses 23. A washer 36 may be provided between the fastener 34 and the disc 23 to provide a snug fit. Alternatively, the threadably engageable portion 32 may be formed as a screw having threads while the fastener 34 may be formed as a threaded wing-nut which is torqueable by hand. It is also contemplated that other types of fasteners may be used which are advantageous in securing the disc 22 and the members 16 in place.

Additionally, a retainer plug 38 may be provided which has a plurality of protrusions 39 extending about the periphery of the plug 38. Generally, such plug 38 should be tubularly shaped to engage the upper or lower surfaces 12 and 13. The protrusions 39 allow the plug 38 to be frictionally inserted into the upper or lower surfaces 12 and 13 and retained therein. The plug 38 may further have a circular-shaped rim 40 disposed at the first end 41 of the plug 38 and a chair-receivable opening 42 centrally disposed in the plug 38. The rim 40 has a larger diameter than the plug for mitigating longitudinal movement of the retainer disc 22 when the plug 38 is axially inserted through the central aperture 21. In this respect, the rim 40 acts as a stopper wall to prevent the disc 22 from sliding off of the plug 38. The rim 40 acts collectively with the disc 22 to urge the members 16 into the outer channels 14. The protrusions 39 work to prevent rotational movement of the disc 22 which further allows the plug 38 and disc 22 to retain the members 16 within the outer channels.

The opening 42 may be sized and shaped to receive a chair 24 or any other type of structure which may benefit from the features of the present invention. When the plug 38 is inserted in the upper surface 12 of the body 11, and a chair 24 is inserted into the plug 38, the plug 38 acts as a chair retainer capable of accepting different types of chairs. Advantageously, the plug's 38 size and shape may be varied to accommodate different types of chairs and structures (i.e. tables, stools, hat racks, etc).

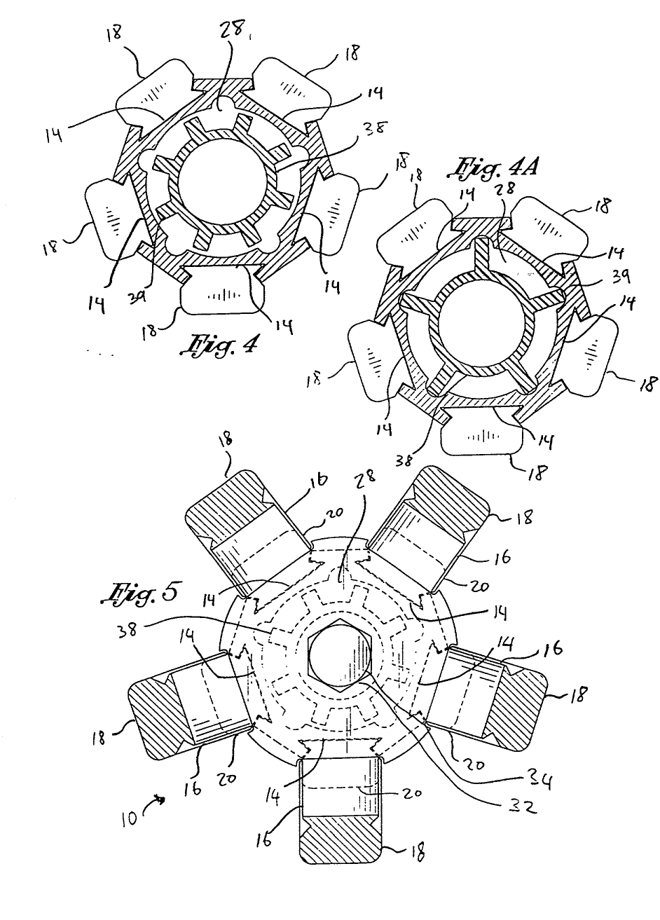

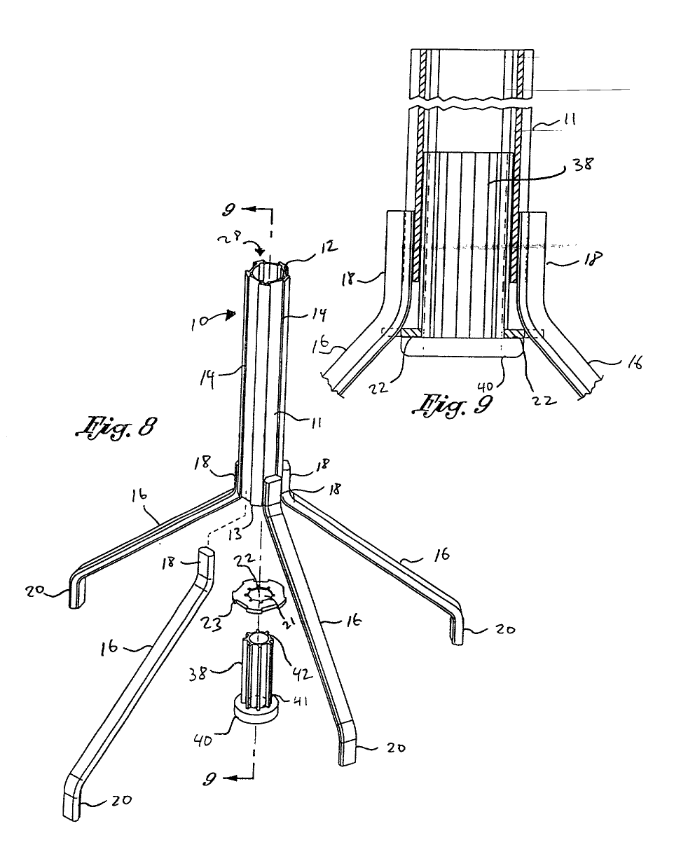

Referring now to FIGS. 4, 4A, 8, 9, a second embodiment of the present invention is shown. All aspects shown and described with reference to the first embodiment should be present in the second embodiment. However, the second embodiment possesses some notable differences. Specifically, the plug 38 may be axially inserted through the central aperture 21 of the disc 22. The central aperture 21 of the disc 22 shall be sized and shaped complimentary to a cross-section of the plug 38. In this respect, the central aperture 21 is formed such that the plug 38 may be sizeable therethrough. However, the central aperture 21 shall be sized and shaped to mitigate or prevent rotational movement of the plug 38 when the plug 38 is inserted through the central aperture 21 of the disc 22. The plug 38 and the disc 23 may then be frictionally inserted into the lower surface 13 of the body 11 via the protrusions 39. Specifically, the protrusions 39, which should be longitudinally disposed along the plug 38, may be sized such that the plug 38 may be inserted into the body 11 by hand and application of force. The protrusions 38 may be of any size and of any number so long as the protrusions 38 allow for a frictional fit of the plug 38 into the body 11.

In use, the members 16 should be slid into the channels 14, and the disc 22 with the plug 38 inserted therethrough will urge the members 16 into the channels 14 and retain them therein. The recesses 23 formed on the disc 22 retain the members 16 within the channels 14 and the plug 38 stays secured within the body 11 through the lower surface 13 via the protrusions 39 formed about the periphery of the plug 38. While it is not essential, such protrusions 39 may be formed to engage an inner wall of the body 11 as shown in FIG. 4, or may further be formed to slide within tracks indented within the body 11 as shown in FIG. 4A. The circular-shaped rim 40 is operative to prevent the disc 22 from slipping off the plug 38.

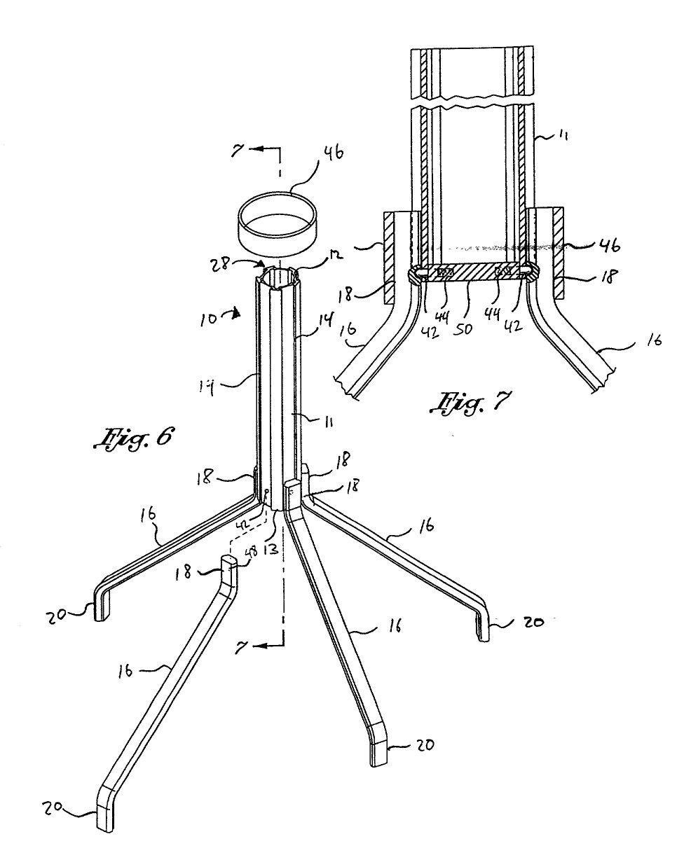

Referring now to FIGS. 6 and 7, a third embodiment of the present invention is shown. While the third embodiment of the present invention is substantially similar to the first embodiment as previously described, there are some notable differences. Specifically, there is provided a plurality of snap-tabs 42 disposed about the outer periphery of the body 11. The snap-tabs 42 are preferably embedded within the channels 14 and outwardly protruding therefrom. The members 16 should be formed having complimentary snap-tab recesses 48 which may matably receive the snap-tabs 42. Further, a spring mechanism 44 is preferably disposed within the body 11 and in mechanical communication with each of the snap tabs 42. The spring mechanism 44 is operative to provide compressive force and urge the snap tabs 42 into the recesses 48. In this respect, when the members 16 are engaged to the body 11 via the channels 14, the substantially straight portion 18 of the member 16 may slide over the protruding snap-tab 42 to compress the snap-tab 42 into the body 11 until the snap-tab 42 is able to once again protrude out of the body 11 and matably engage the recess 48. Advantageously, such a snap-tab allows for the member 16 to be retained within the channel 14 yet removable from the channel 14 if sufficient force is applied to the members. While the snap tabs 42 may be formed within a portion of the body 11, it is preferable that the snap-tabs 42 be formed in a snap-tab-plate 50 formed in the lower surface 13 of the hollow passageway 28. In this respect, the snap-tab plate 50 may be preformed with the snap-tabs 42 and spring mechanism 44 and then later attached to the body 11. The snap-tab plate 50 may be attached to the body 11 by such methods as spot-welding and crimping the edges of the lower surface 13 inward. Alternatively, the snap-tab plate 50 may be frictionally engaged within the body 11 and/or retained therein via spring-action. Preferably, the snap-tabs 42 are formed as ball-bearings which are substantially rotatable such that when the members 16 slide into the outer channels 14, effortless engagement and disengagement may be made between the snap-tabs 42 and the snap-tab recesses 48 while still providing sufficient securement fo the members 16 to the body 11.

Further, a cylindrical retainer ring 46 sized and configured to slide over the substantially straight portions 18 of the members 16 secured within the channels 14 may be provided. Once the members 16 are secured within the channels 14, the ring 46 operates to prevent the members 16 from accidentally being dislodged from the channels 14. The cylindrical ring 46 should be slid over the upper surface 12 and over the substantially straight portions 18. However, the cylindrical ring 46 may be formed to completely encompass the body 11 for aesthetic purposes. Specifically, the ring 46 may be formed from a plastic material such that the ring 46 hides the channels 14 and the members 16 secured therein. While the ring 46 is described herein as being slidable over a third embodiment made according to the present invention, the ring 46, as well as other components described in the foregoing, may be combined with other embodiments.

Additional modifications and improvements of the present invention may also be apparent to those of ordinary skill in the art. Thus, the particular combination of parts described and illustrated herein is not intended to serve as limitations of alternative devices within the spirit and scope of the invention.

What is claimed is:

1. A universal post base for supporting a chair comprising:
an elongated and generally tubular body having upper and lower surfaces, and a plurality of outer channels disposed longitudinally therealong; and
a plurality of post support members, at least a portion of each post support member defining a cross-section substantially corresponding to the outer channels such that the post support members are retractably engageable thereto, the post support members extending radially from the tubular body for supporting the chair.

2. The universal post base of claim 1 wherein each post support member has a substantially straight portion for engaging the outer channel and a substantially curved portion for defining a support base.

3. The universal post base of claim 2 wherein the substantially straight portion is frictionally insertable within the outer channels and retainable therein.

4. The universal post base of claim 1 wherein the body and the post support members are each fabricated from an aluminum material.

5. The universal post base of claim 1 wherein the body and the post support members are each fabricated from a steel material.

6. The universal post base of claim 1 further comprising a retainer disc having a plurality of recesses formed thereon for receiving the post support members.

7. The universal post base of claim 6 wherein the retainer disc is substantially planar.

8. The universal post base of claim 6 wherein the retainer disc is fabricated from a plastic material.

9. The universal post base of claim 6 further comprising a tubular retainer plug having a plurality of radially extending protrusions for securing the plug when inserted within the body.

10. The universal post base of claim 9 wherein the the protrusions are disposed longitudinally along the plug.

11. The universal post base of claim 9 wherein the retainer disc defines a central aperture for receiving the plug therethrough.

12. The universal post base of claim 11 wherein the central aperture is sized and configured to correspond to the protrusions of the plug so as to mitigate rotational movement of the retainer disc when the plug is axially inserted through the central aperture.

13. The universal post base of claim 12 wherein the plug has a first end forming a circular-shaped rim, the first end and the rim being in a coaxial relationship with each other.

14. The universal post base of claim 12 wherein the circular-shaped rim has a larger diameter than the plug for mitigating longitudinal movement of the retainer disc when the plug is axially inserted through the central aperture.

15. The universal post base of claim 12 wherein at least a portion of the plug is frictionally insertable into the body through the lower surface thereof, the plug and the retainer disc collectively urging the post support members into the outer channels via the recesses and retaining the post support members within the outer channels.

16. The universal post base of claim 9 wherein at least portion of the plug is frictionally insertable into the body through the upper surface thereof.

17. The universal post base of claim 16 wherein the plug defines a chair-receivable opening formed adjacent the first end for receiving the chair.

18. The universal post base of claim 6 further comprising a member-securing plate formed within the body adjacent the lower surface thereof, the plate having a threadably engageable portion centrally formed therein.

19. The universal post base of claim 18 further comprising a fastener axially insertable through the central aperture of the retainer disc, the fastener further being matable with the threadably engageable portion, the retainer disc and the fastener collectively urging the post support members into the outer channels via the recesses and retaining the post support members within the outer channels.

20. The universal post base of claim 19 wherein the threadably engageable portion is a threaded nut integrally formed within the member-securing plate.

21. The universal post base of claim 15 wherein the fastener is a threaded hand-screw sized and configured to matably engage the threaded nut.

22. The universal post base of claim 2 wherein the body further comprises a plurality of snap-tabs disposed about the body adjacent the lower surface thereof, the snap-tabs being embedded within the outer channels and outwardly protruding therefrom.

23. The universal post base of claim 22 wherein the substantially straight portion of each post support member defines a snap-tab recess formed therein for matably receiving the snap-tabs.

24. The universal post base of claim 23 further comprising a plurality of spring mechanisms each in mechanical communication with a respective one of the snap-tabs, the spring mechanisms providing compressive force to the snap-tabs for urging each snap-tab into the corresponding snap-tab recess.

25. The universal post base of claim 24 wherein each of the snap tabs and spring mechanisms are embedded within a snap-tab plate formed within the lower surface of the body.

26. The universal post base of claim 25 further comprising a cylindrical retainer ring sized and configured to slide over the substantially straight portions of the post support members secured within the outer channels.

27. A universal post base for supporting a chair comprising:
an elongated and generally tubular body having upper and lower surfaces, and a plurality of outer channels disposed longitudinally therealong;
a plurality of post support members, at least a portion of each post support member defining a cross-section substantially corresponding to the outer channels such that the post support members are retractably engageable thereto, each post support member further having a substantially straight portion for engaging the outer channels and a substantially curved portion for defining a support base, the post support members defining a support area extending radially from the tubular body for supporting the chair;
a substantially planar retainer disc having a central aperture and a plurality of recesses formed thereon for receiving the post support members; and
a fastener axially insertable through the central aperture of the retainer disc and engageable to the body, the retainer disc and the fastener urging the post support members into the outer channels via the recesses and retaining the post support members within the outer channels.

28. The universal post base of claim 27 wherein the fastener is a tubular retainer plug having a plurality of radially extending protrusions for securing the plug when inserted within the body.

29. The universal post base of claim 28 wherein the central aperture is sized and configured to correspond to the protrusions of the plug so as to mitigate rotational movement of the retainer disc when the plug is inserted through the central aperture.

30. The universal post base of claim 28 wherein the plug is frictionally insertable into the body through the lower surface thereof.

31. The universal post base of claim 28 wherein the plug is frictionally insertable into the body through the upper surface thereof.

32. The universal post base of claim 31 wherein the plug defines a chair-receivable opening formed adjacent the first end for receiving the chair.

33. The universal post base of claim 27 wherein the plug has a first end forming a circular-shaped rim, the first end and the rim being in coaxial relationship with each other.

34. The universal post base of claim 33 wherein the circular-shaped rim has a larger diameter than the plug for mitigating longitudinal movement of the retainer disc when the plug is axially inserted through the central aperture.

35. The universal post base of claim 27 further comprising a member-securing plate formed within the body adjacent the lower surface thereof, the plate having a threadably engageable portion centrally formed therein.

36. The universal post base of claim 35 wherein the threadably engageable portion is a threaded nut integrally formed within the member-securing plate.

37. The universal post base of claim 36 wherein the fastener is a threaded sized and configured to matably engage the threaded nut.

38. A universal post base for supporting a chair comprising:
an elongated and generally tubular body having upper and lower surfaces, and a plurality of outer channels disposed longitudinally along the body;
a plurality of snap-tabs disposed about the body adjacent the lower surface thereof, the snap-tabs being embedded within the outer channels and outwardly protruding therefrom;
a plurality of post support members, at least a portion of each post support member defining a cross-section substantially corresponding to the outer channels such that the post support members are retractably engageable thereto, each post support member further having a substantially straight portion for engaging the outer channel, and a substantially curved portion for defining a support base, the substantially straight portion of each post support member defining a snap-tab recess formed therein for matably receiving the snap-tabs, the post support members defining a support area extending radially from the tubular body for supporting the chair; and
a plurality of spring mechanisms each in mechanical communication with a respective one of the snap-tabs, the spring mechanisms providing compressive force to the snap-tabs for urging each snap-tab into the corresponding snap-tab recess.

39. The universal post base of claim 38 wherein each of the snap-tabs and spring mechanisms are embedded within a snap-tab plate formed within the lower surface of the body.

40. The universal post base of claim 39 further comprising a cylindrical retainer ring sized and configured to slide over the substantially straight portions of the post support members secured within the outer channels.
